(19) United States
(12) Patent Application Publication
(10) Pub. No.: US 2025/0076811 A1
(43) Pub. Date: Mar. 6, 2025

(54) USE OF A DISPERSIVE OPTICAL ELEMENT AS A SPECTRAL RECOMBINER FOR AN ADVANCED VOLUME HOLOGRAM FILTER (AVHF) AND OPTICAL IMAGING SYSTEMS EMPLOYING SUCH FILTER

(71) Applicant: ARIZONA BOARD OF REGENTS ON BEHALF OF THE UNIVERSITY OF ARIZONA, Tucson, AZ (US)

(72) Inventors: Andrew Suzuki, Tucson, AZ (US); Pierre Alexandre Blanche, Tucson, AZ (US); Pedro Enrique Alcaraz, Tucson, AZ (US); Gregory Michael Nero, Tucson, AZ (US)

(21) Appl. No.: 18/615,917

(22) Filed: Mar. 25, 2024

Related U.S. Application Data
(63) Continuation of application No. PCT/US2022/044815, filed on Sep. 27, 2022.
(60) Provisional application No. 63/249,696, filed on Sep. 29, 2021.

(51) Int. Cl. G03H 1/26

(52) U.S. Cl. CPC G03H 1/26

(57) ABSTRACT

Addition of a light-recombiner in the form of a diffraction grating to an advanced-volume-hologram filter system (conventionally containing only a pre-disperser diffraction grating and a volume holographic filter VHF configured as a volume Bragg grating, VBG) demonstrated recollimation and spatial overlap of light components at different wavelengths in addition to the spectral bandwidth optimization and signal-to-noise improvement. Here, the wide spectral bandwidth is ensured by the angular Bragg-matching of the pre-disperser with the VBG. The signal-to-noise improvement is obtained by the wavefront selectivity of the VBG. The cancellation of the spectral dispersion is achieved by the light-recombiner. Utilization of a light-recombiner in the form of a diffraction grating as opposed to another dispersive optic such as an optical prism additionally eliminates the potential for spatial chirp that normally reduces the usability of the conventional AVHF system in optical imaging applications.

### CROSS-REFERENCE TO RELATED APPLICATIONS

This US patent application is a continuation from the International Patent Application No. PCT/US 2022/044815, filed on Sep. 27, 2022 and now published as WO 2023/055707, which claims priority from and benefit of the U.S. Provisional Patent Application No. 63/249,696 filed on Sep. 29, 2021. The disclosure of each of these patent documents is incorporated herein by reference.

### STATEMENT CONCERNING FEDERALLY SPONSORED RESEARCH AND DEVELOPMENT

This invention was made with government support under Grant No. N00173-16-C-6013 awarded by NAVY/NSWC. The government has certain rights in the invention.

### TECHNICAL FIELD

The invention generally relates to optical filtering of light facilitating the process of optical imaging and/or observation of objects and, in at least one case, to optical imaging systems employing the so-called advanced volume hologram filter (AVHF) and methods for compensation of the spectral dispersion of such filter (which otherwise leads to the AVHF-caused chromatic aberrations of the image) for use, for example, in optical detection of objects during daytime under conditions when bright daylight collected by the imaging system may at least partially conceal the object.

### SUMMARY OF THE INVENTION

Embodiments of the invention address a problem of at least reducing (or even substantially completely nullifying) the amount of light that arrives at the optical imaging system from the space surrounding the target object (object of interest) from reaching the optical detector, thereby increasing the spatial and/or spectral selectivity of imaging of the target object in background light while, at the same time, increasing the signal-to-noise ratio of the desired, sought after signal in comparison with that provided by the background.

In particular, embodiments of the invention provide an optical filter system that include a first optical diffractive element configured to receive an input beam of light having an input light wavefront and to diffract said input light wavefront into a first light wavefront; a second optical diffractive element disposed to receive the first light wavefront and to diffract the first light wavefront into a second light wavefront; and a third optical diffractive element positioned to receive the second light wavefront and to diffract said second light wavefront into a third light wavefront. Here, the optical filter system is configured such that—when the input beam of light is a substantially collimated polychromatic beam of light containing first light at a first wavelength and second light at a second wavelength—the third light wavefront is also a substantially planar wavefront having a first portion containing the first light and a second portion containing the second light. Substantially every implementation of the optical filter system may be configured such that the first and second portions of the third light wavefront substantially spatially overlap in a first plane transverse to a direction of propagation of the third light wavefront and in a second plane substantially parallel to and separated from the first plane, while the third light wavefront represents an output beam of light that is substantially collimated; and/or configured such that the first light wavefront is a light wavefront spatially diverging upon propagation from the first optical diffractive element while the second light wavefront is a light wavefront that is spatially converging upon propagation from the second optical diffractive element. Alternatively or in addition, and substantially in every embodiment, the optical filter system may be configured such that the second optical diffractive element is disposed to receive the first light wavefront from the first optical diffractive element directly—that is without any optical device or component between the first and second optical diffractive elements—and/or such that the third optical diffractive element is disposed to receive the second optical wavefront from the second optical diffractive element directly—that is without any optical device or component between the second and third optical diffractive elements. In at least one specific case, the embodiment of the optical filter of the invention is structured to have a first spectral bandwidth of the first optical diffractive element be broader than a second bandwidth of the second optical diffractive element, and to have a third spectral bandwidth of the third optical diffractive element be broader than the second bandwidth; and/or to have the first optical diffractive element be configured as a first holographic diffractive grating, the second optical diffractive element be configured as a second holographic diffractive grating, and the third optical diffractive element be configured as a third holographic diffractive grating while at least one of the following conditions is satisfied: i) periods of the first and second holographic diffractive gratings are substantially equal; ii) spectral bandwidths of the first and third holographic diffractive gratings are substantially equal; iii) thicknesses of said first and third holographic diffractive gratings are substantially equal. Alternatively or in addition, substantially in every embodiment of the optical filter system the first optical diffractive element may be configured as a first holographic grating having a first thickness, the second optical diffractive element may be configured as a second holographic gratings having a second thickness, the third optical diffractive element may be configured as a third holographic diffraction grating having a third thickness, while the third thickness is smaller than the second thickness. Alternatively or in addition, substantially every embodiment of the optical filter system the first optical diffractive element may contain a diffraction grating characterized by a first spatial frequency, the second optical diffractive element may contain a diffraction grating characterized by a second spatial frequency, and the third optical diffractive element may contain a diffraction grating characterized by a third spatial frequency, while the third spatial frequency is substantially different from the second spatial frequency. Furthermore, substantially in every embodiment of the first optical diffraction element may be structured to operate near a boundary between the Bragg regime of diffraction and the Raman-Nath regime of diffraction at wavelengths present in the input beam of light, and/or the second optical diffraction element may be configured to operate near a boundary between the Bragg regime of diffraction and the Raman-Nath regime of diffraction at such wavelengths. Additionally, substantially every embodiment of the optical filter system may be configured such that each of the first and third diffractive optical elements is inclined with respect to an axis along which the input beam of light is made to propagate while absolute values of first and second angles at which the first and third optical diffractive elements are inclined with respect to the axis are substantially equal; and/or such embodiment may additionally include a fourth optical diffractive element that is substantially structurally identical to the second optical diffractive element (in this case, the fourth optical diffractive element is configured between the second and third diffractive optical elements to diffract light incident thereon at an angle that is opposite to an angle of diffraction characterizing the second optical diffractive element.)

Embodiments of the invention additionally provide an optical imaging system that includes any of the embodiments of the optical filter system identified above, as well as an optical detector positioned to receive light transmitted through such optical filter system and to generate an output signal representing a distribution of irradiance of light across the optical detector. An embodiment of the optical imaging system additionally contains a combination of at least a first optical element and a second optical element, each of which is dimensioned to change a degree of divergence of light incident thereon. (Here, the first optical element from the combination may be optionally disposed to transmit the light incident thereon towards the first optical diffractive element, while the second optical element from the combination may be disposed to receive the third light wavefront and to relay it to the optical detector.) In at least one implementation, the combination of the first optical element and the second optical element may be configured as a telescope; and/or the first optical element and the second optical element may be not disposed co-axially with one another.

Embodiments of the invention further provide a method of optically imaging an object. Such method involves receiving an input beam of light from the object at the optical filter system according to any of the embodiments identified above, sequentially transmitting light from the input beam of light through each of constituent diffractive optical elements of the optical filter system, and forming an optical image of the object at an optical detector through a back lens element positioned between the optical filter system and the optical detector. In at least one implementation, the step of forming an optical image of the object may additionally include transmitting light from the input beam of light through a front lens element positioned between the object and the optical filter system. (In at least one specific case, the combination of the front and back optical elements may present a lens arrangement defining an optical telescope, in which case the employed embodiment of the optical filter system is disposed within such telescope.) In at least one implementation of the method, the step of sequentially transmitting may include spatially diverging light while propagating such light between a first constituent diffractive optical element having a first thickness towards a second constituent diffractive optical element having a second thickness that is greater than the first thickness; and/or be devoid of—that is, does not include—transmitting such light through an optical element that is not a diffractive grating. Furthermore, an embodiment of the method may additionally include—when the input beam of light is a polychromatic beam of light—propagating said light from the input beam of light from the optical filter system towards the optical detector with chromatic dispersion not exceeding 1.9e⁻⁴ degree per nanometer.

### BRIEF DESCRIPTION OF THE DRAWINGS

The following disclosure will be better understood in reference to the following accompanying generally not-to-scale Drawings, of which:

FIG. 1A shows plots representing diffraction efficiency curves according to the angle of incidence (blaze curve) of volume holographic filters with different thicknesses (d=10, 100, and 1000 μm) and different index contrast values. The hologram index modulation varies in inverse proportion to the thickness. The grating spacing for each of the holographic filters is 327 lp/mm, the wavelength of incident light is 532 nm.

FIG. 1B is a plot of a spectrally-dependent diffraction efficiency characteristic of a volume hologram designed to operate at a chosen angle of incidence.

FIG. 1C illustrates schematically a spectral dispersion action performed by a diffraction grating: The different wavelengths of the incident beam are spatially separated in the imaging plan of the detector.

FIG. 1D depicts schematically a process of diffraction of light with a narrow spectral bandwidth by a thick volume holographic grating.

FIG. 1E presents an optical configuration containing an embodiment of a two-element advance volume holographic filter (sub)system 150 in which a pre-dispersor element is configured to match the Bragg angles of various spectral components of light with the operational parameters of the thick volume hologram.

FIG. 2 illustrates the use, in an optical imaging system, of two substantially identical and parallel to one another holographic gratings for correction of the dispersion effects. Light components at each and all of the wavelengths from the spectral band are focused at one single point at the imaging plan of the detector.

FIG. 3 schematically shows the use of an embodiment of the invention, in which an recombiner dispersive element is disposed down the optical axis after the two-element AVHF system 150 of related art to collimate light at each of the different wavelengths present in the spectrum of the input light so an to obtain the image of the source of light substantially without chromatic aberrations otherwise caused by the two-element AVHF sub-system 150.

FIGS. 4A, 4B schematically present the ZEMAX ray tracing simulation for a collimated, polychromatic beam incident on 70.9° (θ_{R,VHF}) AVHF systems without (FIG. 4A) and with (FIG. 4B) the RC element. Beams at 486 nm (blue, B), 532 nm (green, G), 633 nm (red, R), and 800 nm (maroon, M) are traced through the corresponding filter system. The dispersion measurement scheme is indicated in the two-element system of relate art of FIG. 4A.

FIGS. 5A, 5B illustrate the residual spectral dispersion, possessed by the sub-systems of FIGS. 4A and 4B at the outputs of these sub-systems, respectively, with respect to the design wavelength of 532 nm. Note the change of scale between the two graphs.

FIGS. 6A, 6B demonstrate the results of Zemax simulations in terms of the beam spot diagrams for light with the spectral bandwidth containing 4 discrete wavelengths (486 nm, 532 nm, 600 nm, 800 nm) at a plane behind the last diffractive element of the sub-systems of FIGS. 4A and 4B, respectively. FIG. 6A: when the filter system includes only the AVHF without the recombiner element (see FIG. 4A), light at the 4 wavelengths is spatially dispersed with the dispersion angle dependent on the wavelength. FIG. 6B: with the addition of the diffractive recombiner element, the spectrally-different portions of light exit the so-amended AVHF sub-system while substantially overlapping each other and being substantially collimated at the same time.

FIGS. 7A, 7B illustrate experimentally verified comparison of spectral dispersion (between 532 nm and 633 nm light beams) at the output of the conventional two-element AVHF sub-system (FIG. 7A) and at the output of the embodiment of the three-element AVHF sub-system utilizing the RC element according to the idea of the invention. The cross-sectional light distributions were acquired at a screen carrying a 5×5 mm² grid and disposed at about 100 cm following the last diffraction grating in each sub-system.

FIGS. 8A, 8B, 8C: Spatial light distributions acquired in a plane positioned across the direction of propagation of light through the embodiment of the amended AVHF sub-system of the invention at different locations. FIG. 8A: Polychromatic incident beam; prior to pre-dispersor. FIG. 8B: beam in the far field (˜detector plane) after the two-element AVHF without the use of a recombiner. FIG. 8C: beam in the far field (˜detector field) after the three-element embodiment of the AVHF utilizing the recombiner according to the idea of the invention.

Generally, the sizes and relative scales of elements in Drawings may be set to be different from actual ones to appropriately facilitate simplicity, clarity, and understanding of the Drawings. For the same reason, not all elements present in one Drawing may necessarily be shown in another.

### DETAILED DESCRIPTION

The holograms have already been used to transform (vi diffraction) an incident optical wavefront into a predetermined optical wavefront—for example, the use for this purpose of volume holograms configured as optical diffractive elements. One example of such transformation of the incident wavefront is the formation of holographic 3D images that are generated from an incoming plane wave. The use of volume holograms to selectively filter—as a result of optical diffraction—a specific wavefront from the plurality of incident wavefronts has not been practically employed yet, however.

When an optical diffractive element defined by the volume hologram is thick enough for the light wave to consistently interact with the index modulation pattern defining such optical diffractive element, the known Bragg condition is enforced, and the efficiency of diffraction (interchangeably referred to herein as diffraction efficiency) decreases dramatically outside of the angular region represented by this specific condition:

$$sin {θ}_{B} = m \frac{λ}{2 Λ} \qquad ( 1 )$$

Here, θ_{B} is the Bragg angle, λ is the wavelength of light, Λ is the fringe spacing of the holographically-defined diffraction pattern of the optical diffractive element (˜the period of the holographic diffraction grating), and m is the order number (integer).

This property can be used to diffract a predetermined wavefront, while letting other wavefronts pass through the material unaffected. This can be used to select the light coming from a precise distance, such as a satellite, and discard the light coming from other sources, such as sky scattering. Indeed, light emitted from different distances have different wavefront curvature to which the hologram is sensitive.

Holograms that have a narrow band selectivity can be referred to as “thick”: such holographic diffraction elements operate in the Bragg regime. (Such thick volume Bragg gratings (VBG) have been used for wavefront selectivity in various applications such as data storage, endoscopy, or astronomic observation.) Holograms that are not as selective, comparatively speaking, often referred to as “thin”, and operate in the Raman-Nath regime. The transition between these two regimes of operation is not abrupt, but varies gradually with the thickness of a particular hologram and other hologram-related parameters. The mathematical criterium that defines the boundary between the two regimes of operation captures such parameters and is expressed with a parameter Q, which for the purposes of this disclosure may be interchangeably referred to as a Klein Cook parameter and which is defined as:

$$Q = \frac{2 πλ}{n {Λ}^{2} cos θ} d \qquad ( 2 )$$

Here, d is the thickness of the hologram, and n is the index of refraction of the material of the hologram, and Λ is the fringe spacing of the diffraction pattern. When Q<1, the hologram is not selective and is referred to as thin. When Q is definitely greater than 10, the hologram is considered to operate in the Bragg regime, it is more “selective”—for example, in angular space, and is referred to as “thick”.

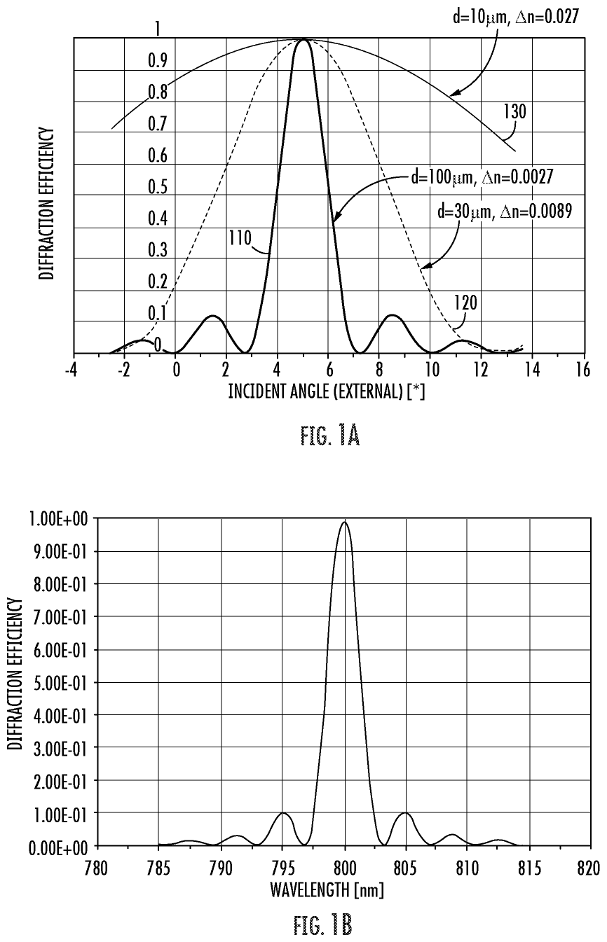

The angular selectivities of different holographically-defined optical diffractive elements can be assessed by comparing their blaze curves. A blaze curve represents the dependency of efficiency (with which the hologram diffracts the incident optical wavefront) on the angle of incidence of such wavefront onto the hologram. Among other known techniques, the blaze curve can be calculated with the use of the Kogelnik coupled-wave analysis, for example. As an illustration, FIG. 1A shows several plots —110, 120, and 130—illustrating blaze curves for various holograms (each of which is characterized by corresponding thicknesses and refractive index contrast values, and each of which is configured to operate optimally, at a given wavelength of light, at a chosen angle of incidence chosen to 5 degrees, in this instance). It can be observed that when the physical thickness of a holographically-defined diffraction grating increases, the angular selectivity of operation of such volume hologram increases as well.

Understandably, once the nominal angle of incidence of a wavefront on a given hologram (configured as an optical diffractive element) has been chosen, the diffractive efficiency of such hologram also exhibits spectral selectivity; that is, the diffraction efficiency of such holographic diffractive optical element is a function of wavelength of light, incident on the hologram at the nominal angle—see the example of FIG. 1B. FIG. 1C schematically illustrates spectral dispersion (of RGB—polychromatic) light by a given hologram configured as an optical diffractive element. The different wavelengths of the incident beam are spatially separated in the imaging plan of the detector.

To filter the incident light according to a distance at which such light is emitted, the volume hologram (˜holographic diffraction grating) has to be rather thick (up to several mm). Unfortunately, when such hologram is very thick, it is also very selective in wavelength. In this condition, the volume hologram only diffracts a very small bandwidth as is schematically presented in FIG. 1D, where only a small portion of the otherwise polychromatic spectral bandwidth of the incident light (shown as G) is diffracted, as intended, towards the imaging system (depicted by a lens element) while the majority of light (see R, B) is wasted for practical purposes.

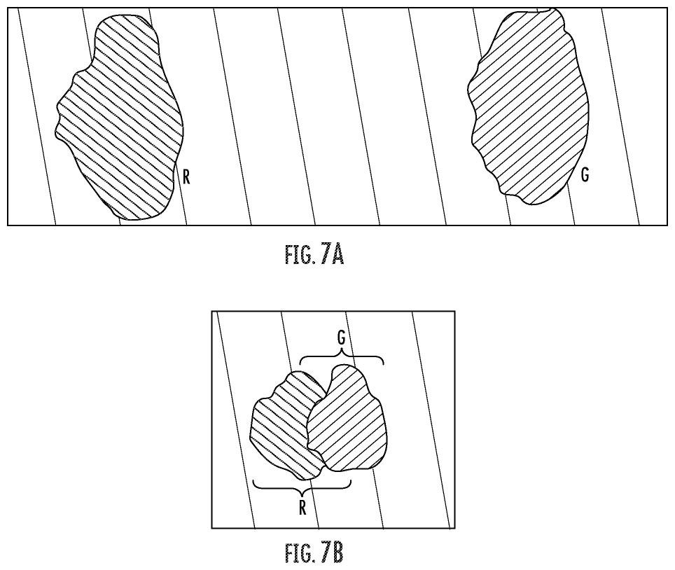

Recently, the invention discussed in U.S. Pat. No. 10,976,478 (or the '478 patent, the disclosure of which is incorporated herein by reference) addressed a question of facilitating the selective imaging of a part of an overall field-of-view (FOV) of an optical imaging system based on addressing the spatial (in particular—angular) and/or wavelength selectivity of a volume hologram judiciously configured as an optical filter that is part of the overall optical imaging system. As a result of such selective optical imaging of a sub-portion of the FOV, the object of interest within the FOV can be imaged while light received by the imaging system from the background or “unwanted” portions of the imaging scene is being generally rejected or ignored or not used, from the point of view of the imaging process. (For example, the imaging of a target object in space occurs while, at the same time, rejecting or reducing the level of a background signal associated with daylight in the atmosphere.) The methodology of incoming light filtering provided by the U.S. Pat. No. 10,976,478 was based on using a so-called pre-disperser hologram in combination with the thick volume hologram (or volume Bragg grating, VBG) to match light at different wavelengths in the incoming incident beam to their respective Bragg angles in the chosen thick volume hologram (see the schematic of FIG. 1E). In other words, the invention discussed on the '478 patent employed two (not one) diffractive elements in an Advanced Volume Holographic Filter (AVHF) configuration. This AVHF took advantage of a pre-dispersive diffraction grating with a large spectral bandwidth that couples the beam at Bragg incidence to the selective, thick hologram (VBG filter). The use of such combination of the pre-disperser element and the thick volume hologram (referred to herein as an advanced volume holographic filter, or AVHF)—as discussed in the '478 patents and, in particular, in the portion of the disclosure of the '478 patent related to FIG. 7 thereof—resulted in a drastic practical improvement of the operation of the holographic-grating portion of the overall system in that the thick volume hologram was then enabled to handle (diffract towards the imaging optics of the system) significantly larger portion of incident light (and within the respective significantly larger portion of the overall spectral bandwidth of such light). In the schematic illustration of FIG. 1E, such substantially larger portion of incident light is shown to include all of R (red), G (green), and B (blue) spectral bandwidths. As a result, the AVHF filter sub-system 150 of related art, when used in the overall optical imaging system 100 allows the user to select a portion of the incoming wavefront according to the distance at which such portion originated, but still have the benefit of keeping a large spectral bandwidth. The AVHF configuration 150 was shown in '478 patent to increase energy throughput compared to using a single thick volume hologram. In particular, It was demonstrated that this design improved the SNR (by more than 3 dB), as well as the spectral bandwidth (by nearly 400 times) as compared to the system employing only the thick volume hologram (that is, the VBG alone). See, for example, P. E. Alcaraz and P. A. Blanche, “Advanced volume holographic filter to improve the SNR of polychromatic sources in a noisy environment,” Opt. Express 29, 1232-1243 (2021), the disclosure of which is incorporated by reference herein.

However, in order to successfully incorporate/implement the two-grating-based AVHF 150 of the '478 patent into an imaging system, specific additional optics is required to correct for the AVHF 150 residual angular dispersion primarily caused by the bandwidth improvement provided by the AVHF 150.

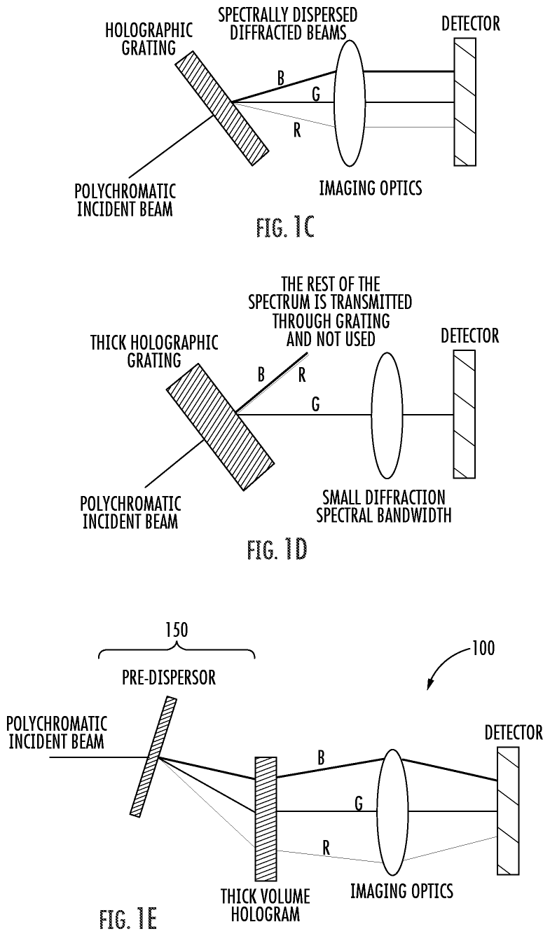

Indeed, generally (and definitely in practical applications discussed in the '478 patent), the pre-disperser and the thick volume hologram constituent components of the AFHF are necessarily oriented such that the corresponding planes of these two elements are not parallel to one another. This situation, however, presents a practical problem. While, as has been known in related art, cascading (˜disposing in sequence, see FIG. 2) of two identical gratings configured to diffract light at angles of opposite signs leads to compensation for the gratings' spectral dispersions and allows to have the emerging through the second grating beam E to be collimated at each of the wavelengths and have spectrally-different portions of the emerging beam E spectrally collimated and overlapping with one another (thereby forming an image without spectral aberration)—the configuration of the holographic gratings according to the implementation of the AVHF 150 implemented in the '478 patent (according to which the two considered there diffraction gratings are not identical), understandably does not produce the emerging polychromatic beam as substantially collimated and with substantially overlapping different spectral portions of the beam, but instead maintains the emerging polychromatic beam still dispersed in wavelength.

One may opine that having the non-zero spectral dispersion of the polychromatic light beam at the output of the AVHF portion 150 of the optical apparatus may not be necessarily a problem (and may even provide some benefit when and if the overall instrument is used as a spectrometer). However, when the overall apparatus (including the optical imaging sub-system and the AVHF sub-system 150) is configured to be used as an optical imaging system (˜as an actual optical imager), there immediately appears a need for compensation of such dispersion: without such compensation, as the skilled artisan now familiar with the situation will readily understand, the final optical image will necessarily possess substantial chromatic aberrations.

The problem caused by the use of the two-diffractive element AVHF filtering sub-system of related art in the optical imaging apparatus—and, specifically, the problem of formation of an optical image subject to substantial chromatic aberrations caused by spectral dispersion of light passing through the AVHF sub-system of related art—is solved by complementing/amending such AVHF sub-system of related art with an auxiliary dispersive element referred to herein as recombiner, or RC, and configured to re-collimate the overall distribution of light at the output of the filter sub-system by compensating/correcting the wavelength-dependent angular dispersion of light exiting the two elements of the AVHF sub-system of related art. (The resulting embodiment of the so-amended AVHF sub-system, therefore, now contains, according to the idea of the present invention, a pre-disperser or pre-dispersive element PD, a thick volume holographic filter VHF, and a recombiner optical element RC.) The recombiner RC may be configured as yet another holographic grating. In this case, the grating frequency and orientation in space of the RC (defining the angle of incidence of light onto RC) are configured such that all spectrally-different portions of the light beam that are received at the recombiner RC from the spatially-preceding combination of the PD and the VHF and that are diffracted at the recombiner RC at the same diffraction angle regardless of their wavelengths, to enable the imaging portion of the overall optical apparatus to focus light at different constituent wavelengths of the original polychromatic incident beam at the same location at the detector, and to obtain an image of the source that is substantially not aberrated in color.

### Theoretical Considerations.

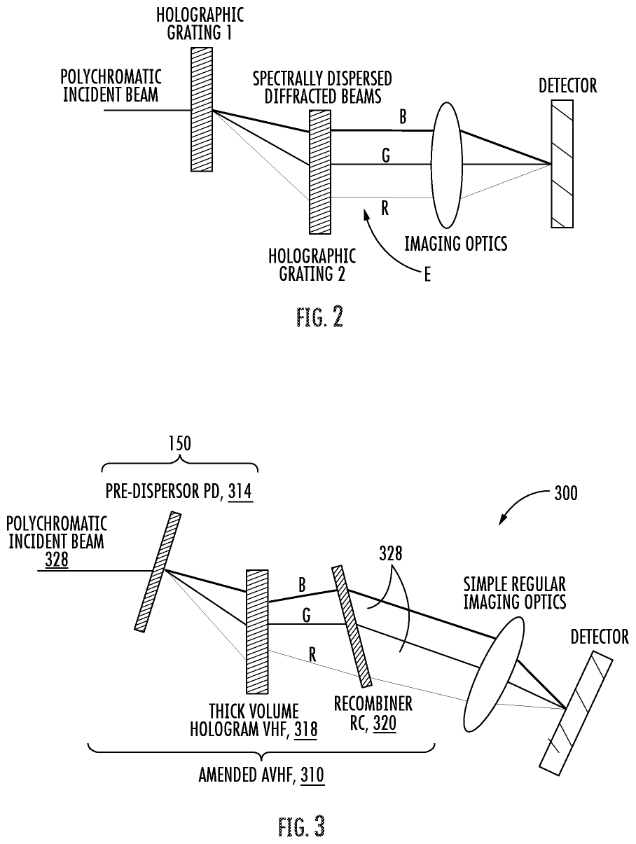

The rough schematic of an embodiment 300 of the optical imaging system structured according to the idea of the current invention is presented in FIG. 3. Here, the transmissive embodiments of the amended AVHF sub-system 310 includes the AVHF sub-system 150 of related art that contains a pre-dispersive element PD, 314 and a thick volume holographic filter VHF,318. The PD, 314 is configured to be a substantially thin grating to operate near or at the boundary between the Bragg and Raman-Nath diffraction regimes (as discussed, for example, in M. G. Moharam and L. Yong, Appl. Opt., v. 17, issue 11, pp. 1757-1759, 1978; Q_{PD} is close to 10 or smaller or in related embodiment Q_{PD}>10), whereas the VHF,318 is configured to operate well within the Bragg regime (Q_{VHF} is much greater than 10, mathematically speaking, for example at least by an order of magnitude, or Q_{VHF}>>10) thereby exhibiting very narrow spectral and angular selectivity. The filter sub-system 310 additionally includes the recombiner RC, 320 (receiving, from the system portion 150, filtered with the portion 150 light 324 from the polychromatic input beam 328 that is incident from the object at the PD, 314). The RC, 320 is configured to correct/compensate the residual angular dispersion of the filtered signal 328 and to also operate near the Bragg/Raman-Nath regimes boundary (with Q_{RC} is close to 10 or smaller or in related embodiment Q_{RC}>10 and, in at least one specific case Q_{RC} being substantially equal to Q_{PD}).

An analytical solution determining the grating parameters of the recombiner element according to the geometry of the AVHF is based on a nested Bragg equation, which takes into account the parameters of the different diffractive elements.

For a single grating, the planar grating period is given by:

$$Λ = {λ}_{R} / 2 sin {θ}_{R} , \qquad ( 3 )$$

where θ_{R} is the recording angle and λ_{R} is a recording wavelength. Both the recording angles and wavelengths of the PD and VHF are determined by the desired bandwidth, AA, and the wavelength range of interest (see P. E. Alcaraz, G. Nero, and P. A. Blanche, “Bandwidth Optimization for the Advanced Volume Holographic Filter,” Opt. Express 30(1), 576-587, 2022; the disclosure of which is incorporated herein by reference).

The derivation for bandwidth optimization is a result of matching the wavelength-dependent diffraction, of the PD to the Bragg criterion imposed by the VHF. For the PD, one considers:

$${θ}_{d} ( λ ) = arcsin ( λ n Λ - sin ( {θ}_{i} ) ) , \qquad ( 4 )$$

whereas, for the VHF:

$${θ}_{B} ( λ ) = arcsin ( λsin ( {θ}_{R} ) / {λ}_{R} ) , \qquad ( 5 )$$

where θi and θd are the incident and diffracted angles for the specified grating element.

Given that both PD and VHF gratings are generally rotated to achieve the desired optical coupling between the two, tilt angles for the PD and VHF gratings are, respectively:

$${ζ}_{PD} = \vert {θ}_{R , PD} \vert , and {ζ}_{VHF} = \vert {θ}_{R , VHF} \vert - \vert {θ}_{R , PD} \vert .$$

Each of the involved diffractive elements is characterized by a precise correspondence angle of incidence of light, and grating frequency for the overall filter system (that is, the combination of the sub-system portion 150 and the recombiner RC, 320). Extending the above equations to include the third dispersive Bragg diffraction grating of the RC. 320, the wavelength-dependent diffraction angle at the output of the RC, 320 can be expressed as

$${θ}_{d , RC} ( λ ) = arcsin ( λ / {n}_{RC} {Λ}_{RC} sin ( {ζ}_{RC} + arcsin ( λ / {n}_{VHF} {Λ}_{VHF} - sin ( {ζ}_{VHF} + arcsin ( λ / {n}_{PD} {Λ}_{PD} - sin ( {ζ}_{PD} ) ) ) ) ) ) \qquad ( 6 )$$

wherein the subscripts denote the grating periods or tilts of the respective diffractive elements.

A person of skill in the art will appreciate that the practical structure of a particular embodiment of the three-element amended AVHF sub-system 310 should preferably be configured based on spatial symmetry, relying on the fact that the dispersion introduced into the sub-system 310 is primarily a result of the presence of the PD, 314 and not the presence of the VHF, 318. Given that diffraction of light at the PD, 314 meets the Bragg criterion of the VHF, 318, the dispersion introduced by the PD,314 is proportional to ∂θ_{B}/θλ and the dispersion introduced by the VHF,318 is proportional to ∂θ_{d,VHF}/∂λ, where θ_{i,VHF}=θ_{B}. Deriving these derivatives yields for the PD,314

$$\frac{\partial {θ}_{B}}{\partial λ} = \frac{1}{\sqrt{1 + {γ}_{PD}^{2}}} \frac{sin ( {θ}_{R , VHF} )}{{λ}_{R}} , \qquad ( 7 )$$

$$with$$

$${γ}_{PD} = \frac{λ}{{λ}_{R}} sin ( {θ}_{R , VHF} ) \qquad ( 8 )$$

### and for the VHF,318

$$\frac{\partial {θ}_{d , VHF}}{\partial λ} = \frac{1}{\sqrt{1 + {γ}_{VHF}^{2}}} \frac{sin ( {θ}_{R , VHF} )}{{λ}_{R}} ( \frac{2}{n} - 1 ) \qquad ( 9 )$$

$$with$$

$${γ}_{VHF} = \frac{λ}{{λ}_{R}} sin ( {θ}_{R , VHF} ) ( \frac{2}{n} - 1 ) . \qquad ( 10 )$$

As n>1 and typically n<2 for photosensitive materials transparent to the visible spectrum, γ_{PD}<γ_{VHF} is always true and ∂θB/∂λ∝∂θ_{d,PD}/∂λ>∂θ_{d,VHF}/∂λ, thereby justifying the consideration that dispersion predominately arises from the PD, 314 component of the filtering sub-system of the overall optical imaging apparatus. Considering the symmetry of the amended AVHF sub-system 310 system with respect to the VHF,318, PD,314 and RC,320 can be made identical in grating period, θ_{R,RC}=θ_{R,PD} accommodating the dispersion of the PD, and the tilt of the RC,320 with respect to the axis of the incident beam is given by ζ_{RC}=−ζ_{VHF} thereby correcting for the small asymmetry introduced by a tilted VHF,318.

It is worth noting that in the ideal case, as the skilled person will understand, in order to obtain a perfectly symmetrical amended AVHF sub-system, one may consider utilizing not three but four diffraction gratings in it (one for PD, one for VHF, one for VHF, and one for RC) while the anti-VHF component in this case would be used at the opposite diffraction angle. However, such a four-element configuration obviously introduces one more dispersion element as compared with the structure 310, which additional element necessarily reduces the overall throughput of the system. Therefore, as a practically-acceptable solution a three-element embodiment 310 of the amended AVHF was considered instead.

### Example of a Practical Embodiment of the Invention

In one practical implementation, the diffraction grating utilized for the VHF component was structured as a grating with a 7.9° Bragg-matching condition at the design wavelength of 532 nm. Each of the two thin, dispersive diffraction gratings (one used as an PD and another as an RC), were recorded at a recording angle of 4.0° and configured for a working spectral bandwidth of Δλ=260 nm. Specifically, all holograms were recorded with a 532 nm Nd:YAG laser in a symmetric recording plane, introducing no slant angle. The 16 μm Bayfol HX200 (n=1.505) film-based PD and RC diffraction grating elements were recorded at the same recording angle of 4.0° with 25 mJ/cm2 optical energy density for 10 seconds, followed by a five-minute exposure to an incoherent source to fix the gratings. In accordance with the phenanthrequinone-doped poly(methyl-methacrylate) (n=1.493) synthesis procedures discussed in in Opt. Express 30(1), 576-587 (2022). A 6 mm thick VHF sample was exposed to 1800 J/cm2 with a recording beam at θ_{R,VHF}=7.9° recording angle. Following the process of recording, 24 hours of dark diffusion at room temperature elapsed before exposing the VHF to the same incoherent source for 24 hours.

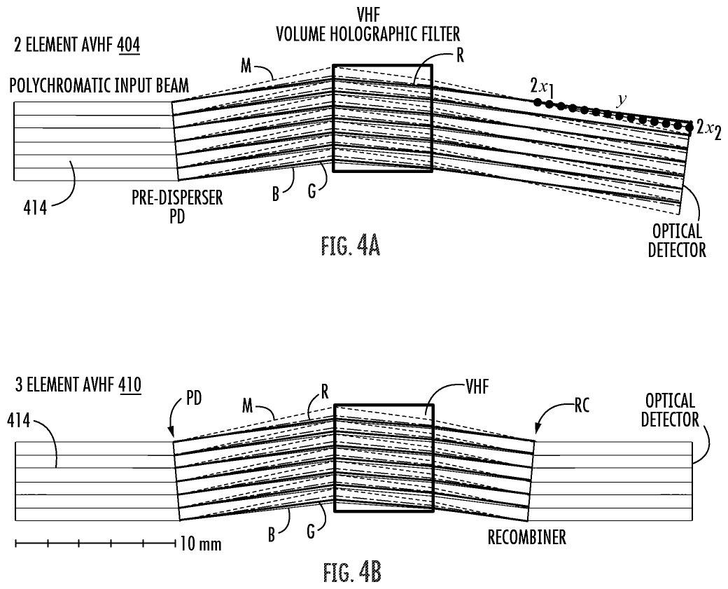

FIG. 4A illustrates in more detail ray-tracing through a two-element AVHF 404 structured similarly to the sub-system 150 according to the idea of related art depicted in FIG. 1E, while FIG. 4A illustrates in more detail ray-tracing through the embodiment of a three-element amended AVHF 410 configured according to the idea of the present invention. Both depictions, presented on the same spatial scale, are the results of a ZEMAX simulation (OpticStudio 21.1.2) for a collimated, polychromatic incident beam 414, with the light at 400 nm (B), 532 nm (G), 633 nm (R), and 800 nm (maroon, M) traced through the corresponding structure. The chromatic dispersion measurement scheme is indicated for the two-element conventional system 404, while this remaining dispersion is corrected by the addition of the collimating RC element in the embodiment 410 in a portion of space where the light portions at different wavelengths exiting the VHF element are substantially simultaneously converging. It can be seen that without the presence of the recombiner RC, the spectrally-different portions of the input beam are not collinear at the output of the AVHF filter system, but when the recombiner is used, portions of light at all constituent wavelengths are collimated and substantially spatially colinear and overlapping.

Spectral and spatial recombination of constituent light portions at different wavelength was both characterized through simulation and experimentally quantified via the dispersion between two collimated, monochromatic light beam source inputs to the amended AVHF sub-system 410.

One was a 532 nm Nd:YAG source and the other a 633 nm HeNe laser. The lateral separation between these monochromatic beams was measured at 10 cm, 2x₁, and 100 cm, 2x₂, following the last grating in either the two- or three-element AVHF embodiment (FIGS. 4A, 4B). Using the distance y between the measurement planes, the dispersion angle relative to the design wavelength was calculated to be

$${δθ}_{d} ( λ ) = arctan ( \frac{{x}_{1} - {x}_{2}}{2 y} ) \qquad ( 11 )$$

Broadband dispersion correction was qualitatively demonstrated using a collimated source with a broadband emission from 450-2400 nm (NKT SuperK Compact supercontinuum laser).

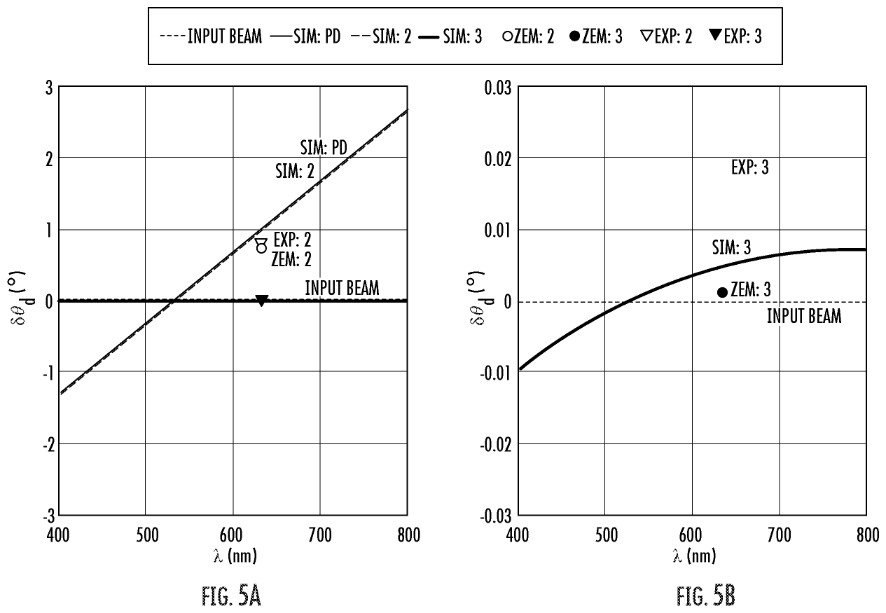

FIGS. 5A, 5B illustrate the residual dispersion of light at the wavelength of 633 nm with respect to light at the design wavelength of 532 nm at the outputs of the sub-systems of FIGS. 4A and 4B, respectively. The dispersion of light at locations following (down-stream) by each of the consecutive diffraction gratings of the embodiments 404, 410 was calculated using Eqs. 4, 6 respectively relative to the system design wavelength of 532 nm (see notations SIM) and ZEMAX (notations ZEM). The experimental measurements were performed at 633 nm and 532 nm by using independent colinear laser beams at these wavelengths with both of these two- and three-element systems (notations EXP additionally labeled “2” and “3”, respectively, in FIGS. 5A, 5B) to provide an empirical comparison therebetween. Two-orders of magnitude of difference in scale between the two graphs evidences stark operational advantage of the amended AVHF embodiment of the invention: in comparison with the collimated input beam, the output of the three-element embodiment of the AVHF system was proved to be collimated to within 0.02°, while the embodiment 404 of the AVHF of related art devoid of the RC necessarily produced a light beam diverging at about 4°. (The stark practical operation improvement factor is about 200×.)

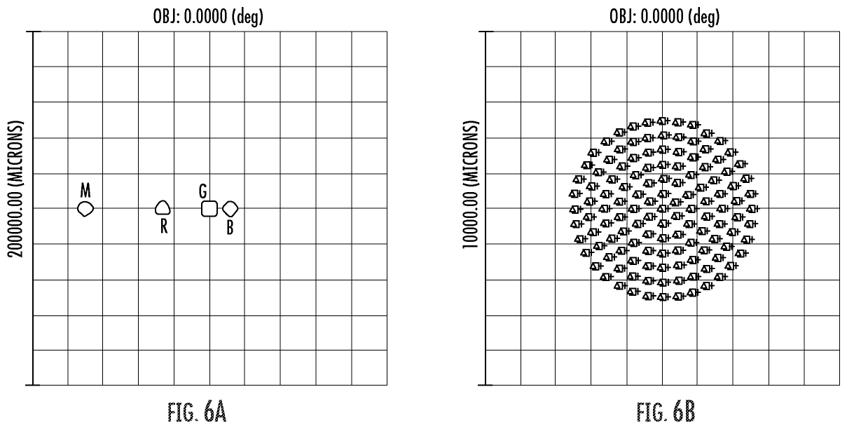

FIGS. 6A, 6B provide the spot diagrams representing the residual dispersion in a plane at about 100 cm behind the last diffractive element for each of the layouts of FIGS. 4A and 4B—that is without the recombiner RC (FIG. 6A), and with the recombiner RC (FIG. 6B). The scale of each of the diagrams, as indicated, is the same for both axes. The spot diagrams confirm that in the optical imaging system employing the two-element AVHF filter sub-system according to related art portions of light at different wavelengths arriving at the optical detector are necessarily spatially separated from another (effectively resulting in the formation of three spectrally- and spatially-distinct images in the image plane, or an overall image with substantial chromatic aberrations), while the optical imaging system in which the AVHF filter sub-system of related art is complemented with the additional recombiner filtering element, different spectral components of the light beam arrive to the imaging plane while substantially overlapping.

FIGS. 7A, 7B, presented at substantially the same scale, demonstrate empirically-acquired images of distributions of light at specific constituent wavelengths (of 532 nm, marked G, and 633 nm, marked R) of the input polychromatic beam that has propagated through the two-element AVFH sub-system of related art (FIG. 4A) and the embodiment of the three-element AVFH-sub-system of the invention (FIG. 4B) containing the recombiner element RC in a plane positioned transversely to the direction of propagation of light at the same distance of about 100 cm following the last grating in each system. In the background of each of these images, a 5×5 mm² reference grid can be seen to illustrate the high degree of compensation of the residual color aberration effectuated with the addition of the RC element according to the idea of the invention.

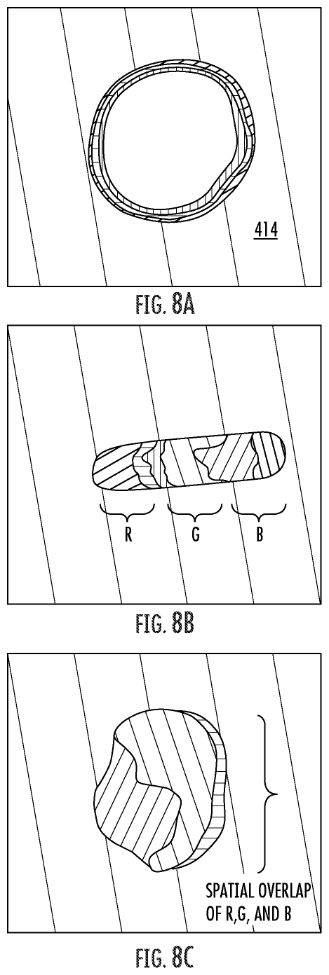

FIGS. 8A, 8B, 8C provide additional visually-perceivable representation of the successful operation of an embodiment of the invention by showing spatial light distribution of the polychromatic input beam propagating through the optical filter system of related art (see FIG. 4A) and that of FIG. 4B registered at various locations along the direction of propagation of light through the sub-systems in another independent experiment at three constituent wavelengths (400 nm, marked as B; 533 nm marked as G, and 633 nm marked as R). Here, FIG. 8A illustrates the cross-section of the input polychromatic beam at location A that is chosen to be prior to the pre-dispersor element PD in each of the sub-systems; location B is the location chosen in the far field after the sub-system of FIG. 4A (that is, without the use of a recombiner RC) which location, in the actual optical imaging system would correspond to the plane of the detector; and location C is chosen in the far field after the sub-system of FIG. 4B that utilizes the recombiner element RC (which location, in the actual optical imaging system would also correspond to the plane of the detector). FIGS. 8A, 8B, 8C present, therefore, convincing experimental verification of the fact that the addition of the recombiner indeed facilitates the process of collimation of spectrally-different portions of the incoming polychromatic beam of light at the output of the AVFH sub-system of related art as well as the process of spatial recombination and/or overlap of such portions of the beam, thereby substantially removing or at least reducing the chromatic aberrations caused by the combination of the PD and the VHF elements of the filter sub-system of the optical imaging system.

Table 1 below summarized values of dispersion angles per wavelength increment for light at constituent wavelengths of 532 nm and 633 nm of the input polychromatic beam that has passed through the prior art embodiment of the AVHF sub-system (FIG. 4A) and through that of the present invention (FIG. 4B).

| | Prior Art AVHF | Amended AVHF |
|---|---|---|
| | (without RC) | (with RC) |
| Grating Coupling Simulation | 9.98E−3°/nm | 4.73E−6°/nm |
| (per Eq. 6) | | |
| ZEMAX Simulation | 7.45E−3°/nm | 1.1E−6°/nm |
| Experimental Verification | 8.01E−3°/nm | 1.9E−4°/nm |

FIGS. 8A, 8B, 8C provide additional visually-perceivable representation of the successful operation of an embodiment of the invention by showing spatial light distribution of the polychromatic input beam propagating through the optical filter system of related art (see FIG. 4A) and that of FIG. 4B registered at various locations along the direction of propagation of light through the sub-systems in another independent experiment. Here, FIG. 8A illustrates the cross-section of the input polychromatic beam at location A that is chosen to be prior to the pre-dispersor element in each of the sub-systems; location B is the location chosen in the far field after the sub-system of FIG. 4A (that is, without the use of a recombiner) which, in the actual optical imaging system would correspond to the plane of the detector; and location C is chosen in the far field after the sub-system of FIG. 4B utilizing the recombiner element (which location, in the actual optical imaging system would also correspond to the plane of the detector). FIGS. 8A, 8B, 8C present, therefore, convincing experimental verification of the fact that the addition of the recombiner indeed facilitates the process of collimation of spectrally-different portions of the incoming polychromatic beam of light at the output of the AVFH sub-system of related art as well as the process of spatial recombination and/or overlap of such portions of the beam, thereby substantially removing or at least reducing the chromatic aberrations caused by the combination of the PD and the VHF elements of the filter sub-system of the optical imaging system.

A skilled person will now, having the advantage of this disclosure, readily appreciate that embodiments of the invention provide a technique for compensation of the spectral dispersion of the two-element AVHF sub-system of related art with the addition of yet another dispersive element disposed at the output from the two-element AVFH of the related art. This new element is configured to act as a spectral recombiner and collimator of light at all different wavelengths of the spectrum of the incoming polychromatic beam.

Having the chromatic aberrations caused by the conventional two-element AVHF substantially eliminated, the optical filter system that includes the two-element AVFH complemented and enhanced with the recombiner optical diffraction component can be used in an optical imaging instrument as a distance filter for optical imaging of objects/scenery characterized by a large spectral bandwidth.

The invention as recited in claims appended to this disclosure is intended to be assessed in light of the disclosure as a whole, including features disclosed in prior art to which reference is made.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes. The expression of the type “element A and/or element B” has the meaning that covers embodiments having element A alone, element B alone, or elements A and B taken together and, as such, is intended to be equivalent to “at least one of element A and element B”.

While the invention is described through the above-described exemplary embodiments, it will be understood by those of ordinary skill in the art that modifications to, and variations of, the illustrated embodiments may be made without departing from the inventive concepts disclosed herein. Disclosed aspects, or portions of these aspects, may be combined in ways not listed above. In particular, various optical imaging systems discussed in U.S. Pat. No. 10,976,478 but now employing any embodiment of the amended AVHF filter sub-system discussed above instead of the two-element AVHF of prior art (and uses of such optical imaging systems, disclosed in the U.S. Pat. No. 10,976,478) are within the scope of the invention: reiteration of the description of operation of such optical imaging systems from the disclosure of U.S. Pat. No. 10,976,478 is not made for the sake of simplicity of presentation, but is included here by virtue of incorporation by reference of the disclosure of U.S. Pat. No. 10,976,478. Accordingly, the invention should not be viewed as being limited to the disclosed embodiment(s).

Operation of an embodiment of the optical imaging system containing an embodiment of the amended AVHF as discussed above may involve the use of programmable processor: some of the steps of the embodiments of the method of the invention can be effectuated with a programmable processor (operably cooperated with at least one piece of hardware of a given embodiment; not shown in Figures for simplicity of illustration). The processor, if present, is controlled by instructions stored in a tangible, non-transitory storage memory. The memory may be random access memory (RAM), read-only memory (ROM), flash memory or any other memory, or combination thereof, suitable for storing control software or other instructions and data. Some of the functions performed by the processor have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware, or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention. Within this specification, embodiments have been described in a way that enables a clear and concise specification to be written, but it is intended and will be appreciated that embodiments may be variously combined or separated without parting from the scope of the invention. In particular, it will be appreciated that all features described herein are applicable to all aspects of the invention.

When the present disclosure describes features of embodiments of the invention with reference to corresponding drawings (in which like numbers represent the same or similar elements, wherever possible), the depicted structural elements are generally not to scale, and certain components may be enlarged or reduced in size relative to the other components for purposes of emphasis and understanding. It is to be understood that no single drawing is intended to support a complete description of all features of the invention. In other words, a given drawing is generally descriptive of only some, and generally not all, features of the invention. A given drawing and an associated portion of the disclosure containing a description referencing such drawing do not, generally, contain all elements of a particular view or all features that can be presented is this view, at least for purposes of simplifying the given drawing and discussion, and directing the discussion to particular elements that are featured in this drawing. A skilled artisan will recognize that the invention may possibly be practiced without one or more of the specific features, elements, components, structures, details, or characteristics, or with the use of other methods, components, materials, and so forth. Therefore, although a particular detail of an embodiment of the invention may not be necessarily shown in each and every drawing describing such embodiment, the presence of this particular detail in the drawing may be implied unless the context of the description requires otherwise. In other instances, well known structures, details, materials, or operations may be not shown in a given drawing or described in detail to avoid obscuring aspects of an embodiment of the invention that are being discussed. Furthermore, the described single features, structures, or characteristics of the invention may be combined in any suitable manner in one or more further embodiments.

1. An optical filter system comprising:
a first optical diffractive element configured to receive an input beam of light that has an input light wavefront and to diffract said input light wavefront into a first light wavefront;
a second optical diffractive element disposed to receive the first light wavefront and to diffract said first light wavefront into a second light wavefront; and
a third optical diffractive element positioned to receive the second light wavefront and to diffract said second light wavefront into a third light wavefront;
wherein the optical filter system is configured such that, when the input beam of light is a substantially collimated polychromatic beam of light containing first light at a first wavelength and second light at a second wavelength, the third light wavefront is also a substantially planar wavefront having a first portion containing the first light and a second portion containing the second light.

2. An optical filter system according to claim 1,
wherein the first and second portions of the third light wavefront substantially spatially overlap in a first plane transverse to a direction of propagation of the third light wavefront and in a second plane substantially parallel to and separated from the first plane,
wherein the third light wavefront represents an output beam of light that is substantially collimated.

3. An optical filter system according to claim 1, wherein the first light wavefront is a light wavefront spatially diverging upon propagation from the first optical diffractive element while the second light wavefront is a light wavefront that is spatially converging upon propagation from the second optical diffractive element.

4. An optical filter system according to claim 1, wherein the second optical diffractive element is disposed to receive the first light wavefront from the first optical diffractive element directly without any optical device or component between the first and second optical diffractive elements and wherein the third optical diffractive element is disposed to receive the second optical wavefront from the second optical diffractive element directly without any optical device or component between the second and third optical diffractive elements.

5. An optical filter system according to claim 1, wherein a first spectral bandwidth of the first optical diffractive element is broader than a second bandwidth of the second optical diffractive element, and a third spectral bandwidth of the third optical diffractive element is broader than the second bandwidth.

6. An optical filter system according to claim 5, wherein the first optical diffractive element is configured as a first holographic diffractive grating, the second optical diffractive element is configured as a second holographic diffractive grating, and the third optical diffractive element is configured as a third holographic diffractive grating, and wherein at least one of the following conditions is satisfied:
(6A) periods of said first and second holographic diffractive gratings are substantially equal;
(6B) spectral bandwidths of said first and third holographic diffractive gratings are substantially equal;
(6C) thicknesses of said first and third holographic diffractive gratings are substantially equal.

7. An optical filter system according to claim 1,
wherein the first optical diffractive element is configured as a first holographic grating having a first thickness, the second optical diffractive element is configured as a second holographic gratings having a second thickness, the third optical diffractive element is configured as a third holographic diffraction grating having a third thickness, and wherein the third thickness is smaller than the second thickness.

8. An optical filter system according to claim 1,
wherein the first optical diffractive element contains a diffraction grating characterized by a first spatial frequency, the second optical diffractive element contains a diffraction grating characterized by a second spatial frequency, and the third optical diffractive element contains a diffraction grating characterized by a third spatial frequency, and wherein the third spatial frequency is substantially different from the second spatial frequency.

9. An optical filter system according to claim 1, wherein the first optical diffraction element is configured to operate near a boundary between the Bragg regime of diffraction and the Raman-Nath regime of diffraction at wavelengths present in the input beam of light, and/or the second optical diffraction element is configured to operate near a boundary between the Bragg regime of diffraction and the Raman-Nath regime of diffraction at said wavelengths.

10. An optical filter system according to claim 1, configured such that each of the first and third diffractive optical elements is inclined with respect to an axis along which the input beam of light is made to propagate, and wherein absolute values of first and second angles at which the first and third optical diffractive elements are inclined with respect to the axis are substantially equal.

11. An optical filter system according to claim 1, further comprising a fourth optical diffractive element that is substantially structurally identical to the second optical diffractive element and is configured between the second and third diffractive optical elements to diffract light incident thereon at an angle that is opposite to an angle of diffraction characterizing the second optical diffractive element.

12. An optical imaging system comprising:
the optical filter system according to claim 1;
an optical detector positioned to receive light transmitted through said optical filter system and to generate an output signal representing a distribution of irradiance of light across the optical detector; and
a combination of at least a first optical element and a second optical element, each of the at least the first optical element and the second optical element dimensioned to change a degree of divergence of light incident thereon,
wherein the first optical element from the combination is disposed to transmit the light incident thereon towards the first optical diffractive element, and
wherein the second optical element from the combination is disposed to receive the third light wavefront and to relay it to the optical detector.

13. An optical imaging system according to claim 12, wherein the combination of the at least the first optical element and the second optical element is configured as a telescope.

14. An optical imaging system according to claim 1, wherein the at least the first optical element and the second optical element are not disposed co-axially with one another.

15. A method of optically imaging an object, the method comprising:
receiving an input beam of light from the object at the optical filter system according to claim 1;
sequentially transmitting light from the input beam of light through each of constituent diffractive optical elements of the optical filter system; and
forming an optical image of the object at an optical detector through a back lens element positioned between the optical filter system and the optical detector.

16. A method according to claim 15, wherein said sequentially transmitting includes spatially diverging said light while propagating said light between a first constituent diffractive optical element having a first thickness towards a second constituent diffractive optical element having a second thickness that is greater than the first thickness.

17. A method according to claim 15, wherein the sequentially transmitting is devoid of transmitting said light through an optical element that is not a diffractive grating.

18. A method according to claim 15, wherein said forming an optical image of the object includes transmitting said light from the input beam of light through a front lens element positioned between the object and the optical filter system.

19. A method according to claim 15, wherein said forming an optical image of the object includes transmitting said light from the input beam of light through an optical telescope that includes said back lens element.

20. A method according to claim 15, further comprising:
when the input beam of light is a polychromatic beam of light, propagating said light from the input beam of light from the optical filter system towards the optical detector with chromatic dispersion not exceeding 1.9e⁻⁴ degree per nanometer.
